(19) United States
(12) Patent Application Publication
(10) Pub. No.: US 2010/0251751 A1
(43) Pub. Date: Oct. 7, 2010

(54) Method for Monitoring the Gas Tightness of a Cooling System for a Refrigerated Vehicle and for Operating the Same and a Cooling System for a Refrigerated Vehicle and a Refrigerated Vehicle

(75) Inventors: Franz Lurken, Kempten (DE); Helmut Henrich, Pulheim (DE); Reinhard Kost, Krefeld (DE)

Correspondence Address: AIR LIQUIDE USA LLC;Intellectual Property, 2700 POST OAK BOULEVARD, SUITE 1800, HOUSTON, TX, 77056, US

(73) Assignee: L'Air Liquide Societe Anonyme Pour L'Etude Et L'Exploitation Des Procedes Georges Claude, Paris (FR)

(21) Appl. No.: 12/296,382

(22) PCT Filed: Mar. 27, 2007
(86) PCT No.: PCT/IB07/51442

§ 371 Date: May 12, 2010

(30) Foreign Application Priority Data
Apr. 7, 2006 (DE) 102006016558.6

(51) Int. Cl. B60H 1/32; G01M 3/32; G08B 21/00

(52) U.S. Cl. 62/440; 73/40; 340/626

(57) ABSTRACT

The invention relates to a method for monitoring the gas tightness of a cooling system for a refrigerated vehicle comprising the following steps: recording of a chronological temperature sequence at least at a first point in the cooling system and the determination of any change in the temperature at the first point within a first time interval and comparison of the change with a first reference value and the triggering of a first warning signal in the event that the change exceeds the first reference value; and/or subjecting a line section of the cooling system to a positive pressure and blocking this line section and recording a chronological pressure sequence at least at a first point in the line section and the determination of any change in the pressure in the second point within a second time interval and comparison of the change with a second reference value and the triggering of a second warning signal in the event that the change exceeds the second reference value. The invention also relates to a method for operating a cooling system, a cooling system and a refrigerated vehicle, in conjunction with which use is made of the method according to the invention. The invention is characterized by high operating safety, operating reliability and economic viability.

The invention relates to a method for monitoring the gas tightness of a cooling system for a refrigerated vehicle and a cooling system for a refrigerated vehicle and a refrigerated vehicle.

For approximately 30 years, nitrogen has been used for the refrigeration of vehicles with multi-chamber systems. A method of this type is already familiar under the name CryogenTrans (CT). The CT method involves carrying nitrogen in liquid form at low temperature in a vacuum-insulated container on or in the vehicle. As and when cold is required, this nitrogen is drawn off via a pipe and is sprayed directly into the chamber to be refrigerated by the inherent pressure of the medium. The method is particularly simple and is immune to interference. What is more, the refrigerating capacity is always at the same level regardless of the ambient temperature. It is restricted in principle only by the flow capacity of the spray nozzles. As a consequence of this, CT refrigerated goods vehicles, which are used in foodstuffs distribution traffic and naturally have numerous door openings, exhibit considerable advantages during refrigerated operation in respect of the quality of the refrigeration. In particular in the height of summer, when mechanical refrigeration plants have to struggle with reduced performance of their condensers and with icing-up of their evaporators, the CT method demonstrates its advantages in terms of efficiency, dependability and performance. After opening a door, it takes only seconds for the reference temperature to be achieved once again.

The method also has its disadvantages, however. The consumption of nitrogen is relatively high, because at least some of the gas sprayed into a chamber also escapes again as exhaust gas. If, for example, a frozen food chamber is refrigerated, the temperature of the exhaust gas will be in the order of −30 to −40° C. The fact that a load space has to be fully ventilated for reasons of safety before being entered is also disadvantageous. An unnecessarily large quantity of warm air enters the load space in this case. Although the renewed reduction in temperature admittedly takes place very rapidly, it consumes more energy and as a result incurs more costs than necessary. The otherwise customary installation of cold retention systems, such as a curtain, is inappropriate in the case of CT refrigerated vehicles, because they would impair the ventilation in a dangerous manner.

EP 0 826 937 describes a refrigeration unit for a chamber to be refrigerated.

EP 1 593 918 relates to an indirect means of refrigeration for refrigerated vehicles, in which a heat exchanger is arranged for the vaporization of low-temperature liquefied gas in a refrigerated chamber.

Liquefied low-temperature nitrogen has a temperature of 77° K. under normal pressure. The cold that is stored in this case is present as two components: on the one hand as a component that is liberated during the phase transition from liquid to gaseous at a temperature of 77° K., and on the other hand as a component that absorbs heat in conjunction with heating of the gaseous phase from 77° K. up to the exhaust gas temperature. The two components, enthalpy of vaporization and specific heat, are of approximately the same size as a rule.

The use of a gas stored in liquid form in a tank and then vaporized for the generation of cold is not unproblematic from the point of view of safety if the gas is able to displace the oxygen in closed refrigerated chambers. Oxygen deficiency is particularly problematic if the refrigerated chamber is to be operated by one person.

One approach to solving this problem is to cool the refrigerated chambers indirectly, that is to say by bringing the cold into the refrigerated chamber not by the direct introduction of the liquefied gas into the refrigerated chamber, but by vaporizing the liquefied gas in an evaporator and by liberating the cold produced in this way to the refrigerated chamber with the help of a heat exchanger, and by conducting the vaporized gas into the free atmosphere via an exhaust pipe. In the case of cooling systems with indirect cooling, the refrigerated chambers can be entered on foot as a rule even in the event of the cooling system becoming unoperational. A certain safety-related risk is always present, in the event of a leak in the cooling system, if the liquefied or vaporized gas finds its way into the interior of a refrigerated chamber. In addition to the disadvantages of an uneconomical mode of operation associated with a leak, the operating safety is reduced considerably by such leaks.

The object of the present invention is to propose a method for monitoring the gas tightness of a cooling system for a refrigerated vehicle, a method for operating a cooling system for a refrigerated vehicle, a cooling system for a refrigerated vehicle and a refrigerated vehicle, by means of which the reliability, efficiency and, in particular, the operating safety is increased in conjunction with refrigeration.

This object is achieved in the manner indicated in the independent claims. Additional advantageous embodiments, further developments and advantageous aspects, which in each case can be utilized individually or combined with one another as required in an appropriate manner, are indicated in the following description and in the dependent claims.

The first method according to the invention for monitoring the gas tightness of a cooling system for a refrigerated vehicle comprises the following steps: recording of a chronological temperature sequence at least at a first point close to the cooling system and the determination of any change in the temperature at the first point within a first time interval; comparison of the change with a first reference value and the triggering of a first warning signal in the event that the change exceeds the first reference value.

A further method according to the invention is indicated alternatively or in combination with this first method.

The further method according to the invention for monitoring the gas tightness of a cooling system for a refrigerated vehicle comprises the following steps: subjecting a line section of the cooling system to a positive pressure; blocking this line section; recording a chronological pressure sequence at least at a second point in the line section and the determination of any change in the pressure at the second point within a second time interval; comparison of the change with a second reference value and triggering of a second warning signal in the event that the change exceeds the second reference value.

Whereas the first-mentioned method takes the chronological temperature sequence as the basis for monitoring the gas tightness of the cooling system, the latter method is based on an analysis of the chronological pressure sequence for a positive pressure in a closed section of pipe.

The temperature sequence and the pressure sequence at the point in each case are recorded in a time-resolved manner, in conjunction with which the time-dependent resolution is advantageously better than two minutes, and in particular better than 1 minute. A time resolution of X seconds means that two identically large Gaussian, trapezoidal or rectangular pressure pulses, for example, exhibiting the amplitude Y and chronologically displaced by X seconds, can be separated from one another by a minimum value present between the two pressure pulses with a depth of 50% of the amplitude Y of the pressure pulses.

A variation in the temperature and/or the pressure is determined from the chronological time sequences in each case. The variation in the temperature and/or the variation in the pressure at each point are related to the time interval in each case. The variation in the temperature and/or the variation in the pressure are understood to be time-averaged and/or to correspond to an average variation. The time averaging in this case is determined in particular by the length of the time interval in each case. For example, the variation can be determined by recording a temperature value or a pressure value at a time T2, and by deducting from this the temperature value or the pressure value at an earlier time T1, in which case the difference between the times T2-T1 corresponds to the length of the time interval in each case. The variation in the temperature and/or the pressure can also be determined by the mathematical integration or mathematical correlation of the temperature and/or pressure sequence with a mathematical test function, such as a Gaussian averaging function. The variation in the temperature and/or the pressure can be understood as a time-dependent derivation of the temperature sequence or a quantity that is proportional thereto. The reason for determining an averaged or average variation in the quantities in each case within an interval of time is to average out short-term, random and/or statistical variations in the temperature and/or in the pressure in chronological terms, so that these variations, which do not have an adverse effect on the operating reliability of the cooling system, do not trigger a warning signal. With the help of the change defined in this way, in particular the time-dependent fluctuations in the temperature sequence and/or in the pressure sequence are recorded quantitatively, so that they can be utilized for evaluating the gas tightness of the cooling system.

In the event of an excessive change in the temperature or the pressure, the corresponding warning signal is triggered. Assigned to the cooling system for this purpose is in particular at least a first and/or a second reference value, by means of which it can be established whether the change in the temperature and/or the pressure lies inside or outside a range of variation for the normal operation of the cooling system. If the value of the variation in the temperature and/or the pressure lies outside a set acceptable range of variation, the warning signal is given.

In the event of the gas tightness testing revealing that the pressure is stable, a further test can be carried out in an advantageous manner, since a stable pressure can be attributable to a double error which arises by chance: on the one hand, a small leak may have occurred in the heat exchanger and, on the other hand, the valve which separates the closed-off internal space from the tank can exhibit a leak of essentially the same size. In such a case, the measurement value for the temperature would not be sufficiently sensitive to detect the leak, and the pressure measurement is deceived by the dynamic balance of the supply flow and the return flow. Against the background of this possible source of risk, the function of the valve, via which gas is supplied, can be tested in an advantageous manner as follows: in a step a, the valve is closed and an exhaust valve, via which the exhaust gas is released into the environment, is opened. In this situation, the pressure in the system must fall to atmospheric pressure. If the exhaust valve is closed in a following step b, the pressure during the test period must remain constant at atmospheric pressure. Not until the following step c is the valve opened, and the pressure of the tank is measured in the previously closed-off area. After these steps, the function of all the valves can be reliably evaluated, and the consistency of the pressure measurement can also be evaluated as evidence of the gas tightness of the system. In the event of an error function being established, a warning signal can also be triggered.

It is possible, alternatively or additionally, to monitor the gas tightness of a cooling system according to a method which comprises the following consecutive steps:
a) Closing of a valve between a tank and at least one of the following elements: a heat exchanger and an evaporator in conjunction with the at least occasionally simultaneous opening of an additional valve, via which a flow connection to an exhaust pipe can be produced, and measuring the pressure between the valve and the additional valve;
b) Closing the additional valve, and the measurement of the pressure between the valve and the additional valve; and
c) Opening of the valve and measurement of the pressure between the valve and the additional valve.

In the case of an intact valve and an intact additional valve—assuming an essentially constant temperature—in step a), the measured pressure should correspond to the ambient pressure outside the cooling system, usually atmospheric pressure. In step b), the measured pressure should be chronologically constant, whereas in step c) an increase in pressure up to an equilibrium pressure and then an essentially constant pressure should be measured. These pressures can be compared in particular with reference values that can be set, in order to enable an error function of the valves to be detected.

The cooling system is based in particular on the vaporization of a low-temperature liquefied gas, such as liquid nitrogen. The liquefied gas is stored in particular in a thermally insulated tank on the refrigerated vehicle. The liquefied gas is advantageously a permanent gas, that is to say a gas which is present in the gaseous physical condition under normal conditions. The boiling point of the gas at normal pressure advantageously lies below −100° C. Gases with higher boiling pints, for example carbon dioxide, can also be used for special applications, however.

The first point for recording the chronological temperature sequence can be provided in a refrigerated chamber of the refrigerated vehicle. This affords the possibility in particular of determining whether liquefied gas enters the refrigerated chamber directly. The first point can also be provided in a pipe section of the cooling system for the liquefied gas. In this case, a leak that is present upstream of the first point can be identified from an increase in temperature at the first point. A leak that is present downstream of the first point can be established under suitable conditions by an excessive reduction in temperature. It is advantageous for the cooling system to exhibit a plurality of first points, at which the chronological temperature sequence is recorded in each case. Under normal operating conditions, the cooling system as a rule exhibits a characteristic temperature distribution or temperature fluctuation distribution. If temperatures or temperature sequences are recorded, which lie outside this temperature distribution or temperature fluctuation distribution, this can indicate a lack of gas tightness. A multiplicity of temperatures and pressures are measured advantageously at different points and are subjected in this way to an evaluation in respect of gas tightness.

The positive pressure in the line section for pressure monitoring can be caused to build up in a line for the liquefied gas in such a way that the exhaust gas side of the line is closed, and by then waiting until a positive pressure arises in the line as a result of the vaporization of liquefied gas in the line and/or in the tank. An inlet to the line section is then blocked, so that the positive pressure in the closed line section is enclosed. If the pressure in the line section falls, this indicates a lack of gas tightness. The line section is closed off or blocked in particular by two valves. The second point is present in the line section that is blocked by the valves. It is advantageous to provide temperature sensors in the line section in order to establish whether liquefied gas is still present in the line section. It is possible, with the help of the temperature sensors, to verify that the pressure measurement is not influenced or falsified by the vaporization of liquid gas. In particular if the pressure in the closed line section increases, it can be assumed that liquefied gas is present in liquid form in the line section.

In order to avoid falsification of the measured pressure values by the subsequent evaporation of liquid nitrogen, a heating period can also be stipulated for the closed line section, in order to ensure that all the liquid gas in the line section is transformed into the gaseous physical condition. The duration of the period required for the line section to heat up adequately can be arrived at from experience. In the case of cooling systems for refrigerated vehicles, the periods in question are in the order of 30 seconds to 3 minutes as a rule. A typical period may be one minute, for example.

The method involving pressure measurement may be repeated advantageously, after waiting for a certain period, if the pressure in the line section increases. The waiting period can be in the order of 30 seconds to 5 minutes, for example, and in particular 1 minute to 2 minutes. The waiting period and the delay ensure that the line section heats up to such an extent that no gas is still present in the liquid phase, and that the liquefied gas has been completely vaporized.

A further warning signal may be given if the pressure lies below a minimum set value. If the pressure lies below the minimum set value, this is an indication of a leak. In particular the anticipated pressure during regular operation of the cooling system must be taken into account in this case.

The method based on pressure measurement can be combined advantageously with the method based on temperature measurement, in conjunction with which the method based on pressure measurement in particular is carried out if the first warning signal, which derives from the method based on temperature measurement, was triggered.

The method based on temperature measurement in particular can represent a preliminary stage of the method for monitoring the gas tightness of the cooling system of the refrigerated vehicle, which, in the event of the existence of the first warning signal, initializes and triggers the method based on pressure measurement.

The first reference value can correspond to a temperature drop not exceeding 20° C. per minute, in particular not exceeding 10° C. per minute, and for example not exceeding 5° C. per minute. In other words, if the temperature at the first point changes by 12° C. within the first time interval, which lasts for 30 seconds, a temperature drop of 24° C. per minute will exist, which lies above the first reference value of 20° C. per minute, with the result that the first warning signal is triggered.

The second reference value can correspond to a pressure drop not exceeding 1 bar per minute, in particular not exceeding 0.5 bar per minute, and for example not exceeding 0.2 bar per minute. For example, if a pressure drop of 1.5 bar per minute is recorded at the second point, the second warning signal will be triggered.

For a rough test, the first and/or the second time interval in particular exhibits a chronological duration of between one second and 300 seconds, in particular between 5 and 100 seconds, and for example between 10 and 60 seconds. With the help of the rough test, larger leaks can be identified. The rough test has the advantage that it can be performed over short periods including during operation of the cooling system. The rough test can be performed permanently or cyclically in principle. Waiting phases, during which the refrigerated chamber does not require any additional supply of cold because it is already sufficiently cold, can be utilized in particular to perform the pressure measurement. The temperature measurement can be performed continuously in principle.

For a fine test, the second time interval can exhibit a chronological duration of between 10 minutes and 24 hours, in particular between 30 minutes and 12 hours, and for example between 1 hour and 4 hours. With the help of the fine test, smaller leaks and the smallest leaks in the cooling system can be identified. The fine test can be performed on the cooling system in particular during longer periods when the refrigerated vehicle is stationary, for example during the night. The pressure test and the fine test can be performed automatically, for example as an auto-diagnosis of the cooling system.

The monitoring of the gas tightness can also be started by turning off the refrigerated vehicle.

The first and/or second warning signal are indicated optically and/or acoustically in particular with an indicator instrument. The indicator instrument can be arranged inside the driver's cab of the refrigerated vehicle. It can be in the form of a clear text display, which draws attention to possible risks.

Monitoring of the gas tightness can be initiated and/or carried out during a defrosting phase of the cooling system.

The method according to the invention for operating a cooling system of a refrigerated vehicle with at least one refrigerated chamber comprises one of the methods according to the invention for testing the gas tightness of the cooling system. In this case, the cooling system exhibits in particular a ventilator, which ventilator is switched off in the event of gas tightness as soon as a door is opened, in order to prevent the ingress of heat and humidity. If the cooling system is not gas tight, the ventilator is switched on if a door of the refrigerated chamber is opened. Operation of the ventilator ensures that adequate oxygen enters the refrigerated chamber. The safety of the cooling system for an operator is further increased in this way.

The cooling system according to the invention comprises at least one tank for liquefied gas, at least one evaporator and a means for testing the gas tightness of the cooling system with at least one temperature sensor and/or at least one pressure sensor for the implementation of one of the methods according to the invention. The refrigerated chamber is provided in particular with a door and a ventilator, in conjunction with which the ventilator is taken into service as soon as the door is opened.

The refrigerated vehicle according to the invention comprises the cooling system according to the invention. By using the cooling system according to the invention for the refrigerated vehicle according to the invention, a high degree of operating reliability is combined with high efficiency, as a result of which the economic viability and safety of the refrigerated vehicles are increased considerably.

Particularly reliable cooling and particularly reliable transport of goods are made possible by the method according to the invention for testing the gas tightness of the cooling system of refrigerated vehicles, the method according to the invention for operating the cooling system of refrigerated vehicles, the cooling system according to the invention and the refrigerated vehicle according to the invention. This is particularly advantageous in particular for refrigerated vehicles with refrigerated chambers that are accessible on foot and/or exhibit an internal volume of at least 2 m³.

Further advantageous aspects and further developments, which can be utilized individually or can be combined with one another in a suitable manner, as required, are explained on the basis of the following drawing, which is intended not to restrict the invention, but only to illustrate it by way of example.

The drawing contains schematic representations of:

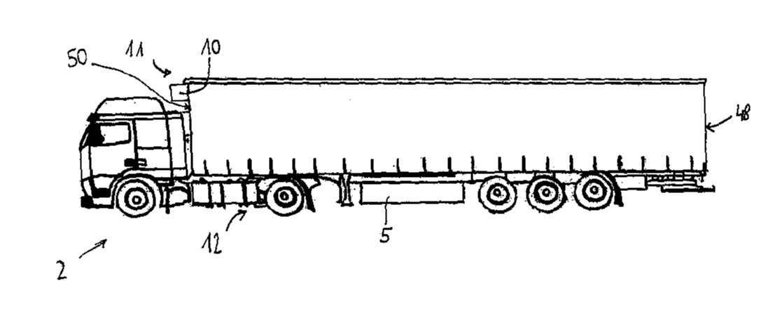

FIG. 1 a refrigerated vehicle according to the invention depicted as a side view;

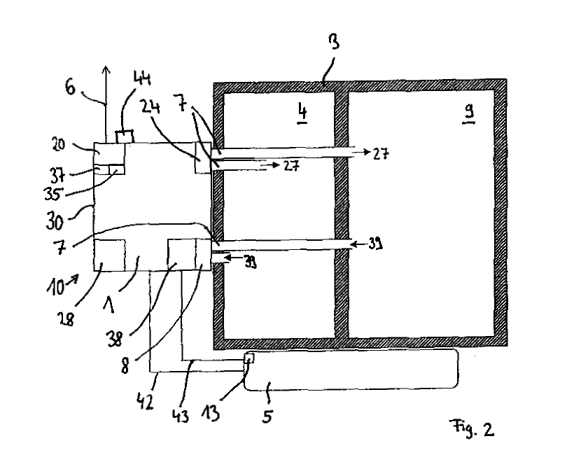

FIG. 2 an evaporator of a refrigerated vehicle according to the invention depicted as a diagrammatic sectioned view;

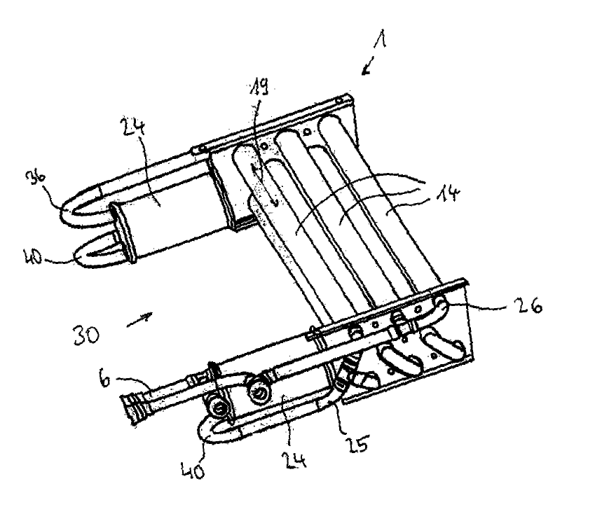

FIG. 3 an evaporator for the refrigerated vehicle according to FIG. 1 depicted as a three-dimensional perspective view;

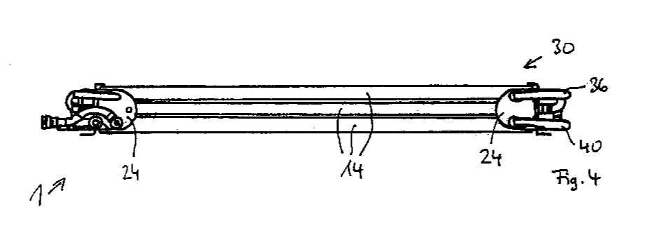

FIG. 4 a side view of the evaporator according to FIG. 3;

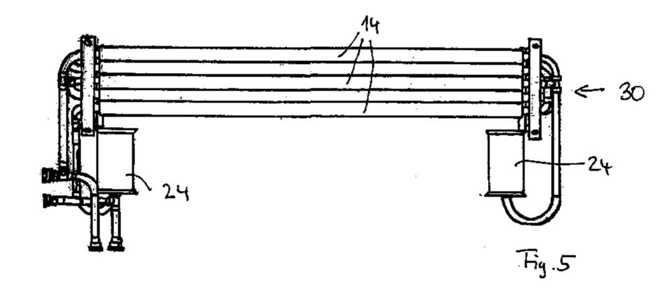

FIG. 5 a top view of the evaporator according to FIGS. 3 and 4;

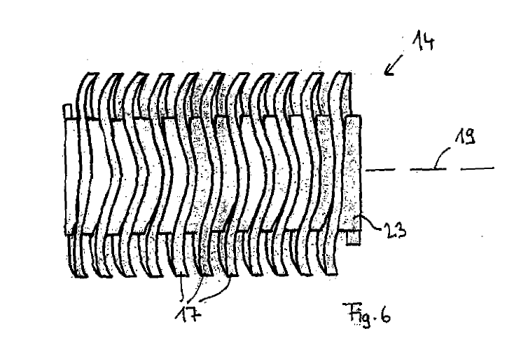

FIG. 6 a pipe of the evaporator according to FIG. 3 depicted as a top view;

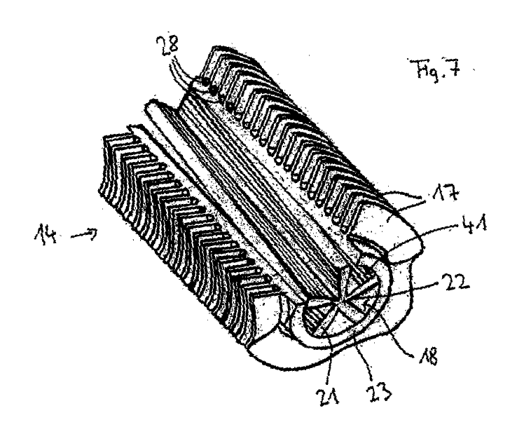

FIG. 7 a sectioned view of a perspective representation of the pipe according to FIG. 6;

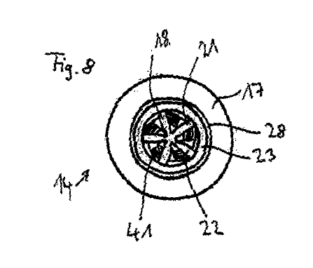

FIG. 8 a cross section of the pipe according to FIGS. 6 and 7;

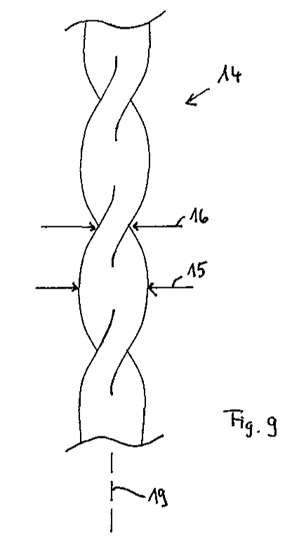

FIG. 9 an additional pipe for an evaporator of a refrigerated vehicle according to the invention depicted as a side view;

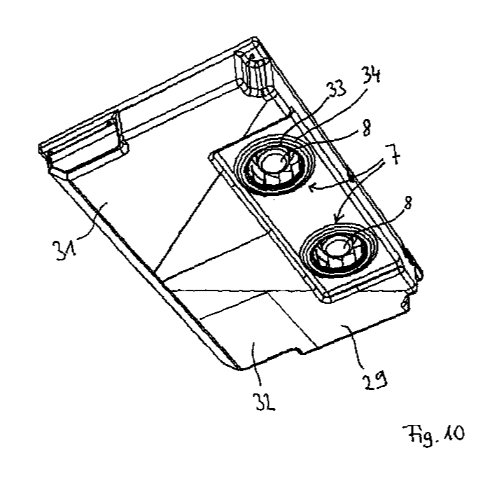

FIG. 10 a housing for a heat exchanger depicted as a perspective oblique view;

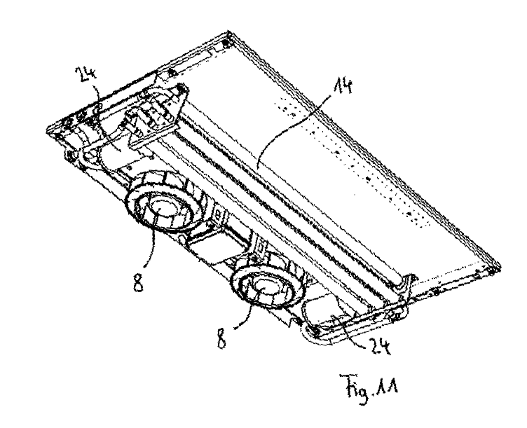

FIG. 11 a refrigeration module of the kind that can be used, for example, in a refrigerated vehicle according to FIG. 1 depicted as a perspective three-dimensional oblique view in the opened form; and

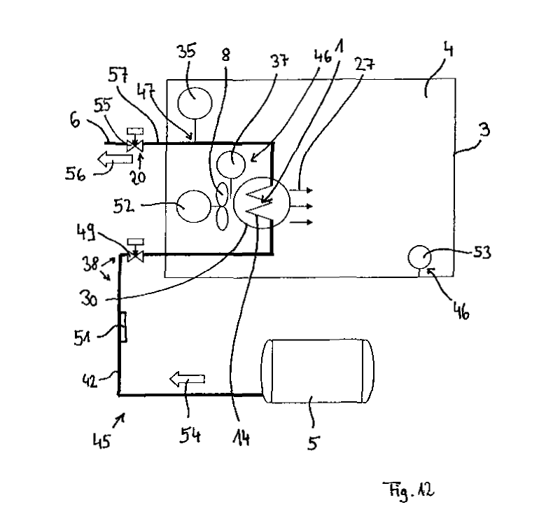

FIG. 12 a pressure generation system according to the invention or a leakage testing system according to the invention.

FIG. 1 depicts a refrigerated vehicle 2 according to the invention as a side view with a refrigeration module 10, which is installed in an upper area on a face 50 of the refrigerated vehicle 2. The refrigeration module 10 comprises an evaporator 1 and heat exchanger 30 (see FIG. 2), which is supplied with liquefied gas from a thermally insulated tank 5. The tank 5 exhibits a jacket for thermal insulation, preferably a vacuum jacket or even a foam jacket, and is connected in a fluid-conducting manner to the refrigeration module 10. The tank is mounted in a lower area 12 of the refrigerated vehicle 2.

FIG. 2 depicts an evaporator 1 arranged outside a refrigerated chamber 4, 9, which evaporator constitutes part of a heat exchanger 30, in order to liberate the cold arising from the vaporization of liquefied gas to a cooling air for cooling 39 taken in from the refrigerated chambers 4, 9. The goods (not shown here) stored in the refrigerated chambers 4, 9 are cooled with the refrigerated cooling air 27. The evaporator 1 is connected in a fluid-conducting manner to the tank 5 by a line 42 for liquefied gas. The exhaust gas that is vaporized and heated in the evaporator 1 is released into the environment via an exhaust pipe 6. The tank 5 is arranged beneath the evaporator 1. The tank 5 stores liquefied nitrogen at a temperature of around 80 Kelvin at a slight positive pressure. The positive pressure inside the tank 5 is used to bring liquefied gas from the tank 5 into the evaporator 1. In the event of the removal of large quantities of gas from the tank 5, and in order to cause pressure to build up inside the tank after filling the tank 5 with liquefied gas, a pressure build-up means 13, preferably a tank heating arrangement, is provided inside the tank, by means of which the liquefied gas can be locally heated and vaporized. The control valve for the pressure build-up means 13 is connected in an electrically conducting manner via a line 43 to a pressure controller 38 on the refrigeration module 10. The pressure inside the tank 5 is regulated with the help of the pressure controller 38. The refrigerated chamber 4 is configured for frozen products and exhibits a temperature between −25 and −18° C. It is also possible, for example, for significantly lower temperatures (−60° C.) to be present. The refrigerated chamber 9 is configured for fresh products and exhibits a temperature between +4 and +12° C. The cooling air is conveyed by means of a ventilator 8 between the refrigerated chambers 4, 9 and the heat exchanger 30 arranged outside the refrigerated chambers 4, 9, for which purpose the refrigerated chambers 4, 9 are connected to the heat exchanger 30 in a fluid-conducting manner via flow channels 7. The refrigerated chambers 4, 9 are surrounded by a refrigerated chamber housing 3. The refrigerated chamber housing 3 provides thermal insulation. The refrigeration module 10 is arranged outside the refrigerated chamber housing 3, which in this case is rectangular in form. The refrigeration module 10 is also thermally insulated.

The refrigeration module 10 exhibits a phase separator 24, through which a component of the liquefied gas that has not been vaporized in the evaporator 1 can be separated from the vaporized gas component. The separated and non-vaporized liquid component is then returned to the evaporator 1. The heat exchanger 30, or the evaporator, 1 exhibits a resistance heating means 28, with which any ice formed on the evaporator 1 or inside the heat exchanger 30 can be defrosted. Defrosting of the ice can also be effected, alternatively or in addition to operating the resistance heating means 28, by recirculating the air from the refrigerated chamber 4. In this case, the air is cooled with the specific heat from the ice and the heat exchanger 30 and the enthalpy of melting. Recirculation does not, in fact, result in a thermal input into the refrigerated chambers 4, 9. This is also true of a refrigerated chamber that is operated at a temperature below zero degrees Celsius, if the air comes from a refrigerated chamber that is operated at a temperature above the freezing point of water and is returned to it. This is possible because the flow channels 7 can be closed during defrosting, so that the refrigerated chamber 4, 9 and the associated heat exchanger 30 are thermally disconnected. Particularly energy-efficient defrosting of the evaporator 1 or the heat exchanger 30 is enabled in this way. The refrigeration module 10, or the evaporator 1 or the heat exchanger 30, additionally exhibits a means 20 for testing the gas tightness of the cooling system and in particular of the heat exchanger 30 and the evaporator 1. Provided for this purpose at various points in the evaporator or in the heat exchanger 30 are pressure sensors 35 and temperature sensors 37, with which the chronological time sequence of the pressure and the temperature in the heat exchanger 30 and the evaporator is determined. It is possible in this way to establish in particular whether a positive pressure remains stable in a closed section of the line in the evaporator 1 or the heat exchanger 30, or whether it falls over time due to leakage. With the help of the temperature sensors, it is possible to establish whether a liquid phase is present in the heat exchanger 30 or in the evaporator 1. Testing of the gas tightness can be carried out at night, for example, when the refrigerated vehicle 2 is stationary. This allows high accuracy of the measurement concerned to be achieved advantageously.

FIG. 3 depicts the evaporator 1 as a perspective view at an oblique angle with pipes 14, in which the liquefied gas is vaporized, and over the external surface of which the cooling air for cooling 39 flows. The pipes 14 exhibit a longitudinal axis 19, at least in segments. Provided on the evaporator 1 are phase separators 24, through which a non-vaporized component of the liquefied gas flowing through the pipes 14 can be separated from the vaporized gas and returned to the pipes 14. An inlet side 26 for the pipes 14 is arranged geodetically lower than an outlet side 25 for the pipes 14. A return line 40 for the phase separator 24 is arranged beneath a supply line 36 for the phase separator 24. A catch tank 31 (see FIG. 10) to catch meltwater during a defrosting sequence is provided below the evaporator 1. The pipes 14 can be folded, helically coiled and wound in meandering form in order to ensure a particularly compact design of the heat exchanger 30 or the evaporator 1.

FIG. 4 depicts the heat exchanger 30 according to FIG. 3 as a side view. FIG. 5 depicts the heat exchanger 30 as a top view.

FIG. 6 depicts a detailed view of the pipe 14 as a top view. The pipe 14 extends along the longitudinal axis 19. The pipe 14 exhibits fins 17 at its periphery, which are pressed directly from the pipe body by a special process—that is to say, they actually represent a workpiece with the pipe 14. The fins 17 can be welded to a pipe pipe wall 23 14. The pipe 14 and the fins 17 are made in particular of copper. A particularly efficient transfer of heat from the cold arising in conjunction with the vaporization and heating of the liquefied gas to the cooling air for cooling 39 is achieved with the help of the fins 17. The fins 17 are undulating in order to increase the surface area per unit of volume, and in order to generate turbulences in the cooling air for cooling 39, as a result of which the liberation of cold and the transfer of cold are increased.

FIG. 7 depicts a sectioned view of the pipe 14 according to FIG. 6 as a three-dimensional perspective view. The pipe 14 exhibits a pipe wall 23, around which the undulating fins 17 are arranged, and to which the fins 17 are attached. The fins 17 can be soldered to the pipe wall 23. In order to simplify defrosting of the fins 17, a resistance heating means 28 is provided between the fins 17. The resistance heating means 28 is constituted by a plurality of electrically insulated wires, which are heated by the effect of an electric current. Elements 18 for the generation of flow turbulences or for the radial separation of liquefied and vaporized gas are introduced into the interior of the pipe 14. The elements 18 are envisaged as baffles 21 and can be inserted into the pipe 14 as a star-shaped profile rod 22. The baffles can be soldered or welded in particular to the pipe wall 23. The profile rods 22 in the pipes 14 are transposed in the longitudinal axis 19. The thickness of a vapour layer formed between the pipe wall 23 and a drop of liquid of the liquefied gas is reduced in this way. The transposition causes the liquefied gas to be forced against the inside of the pipe wall 23 as it flows through the pipe 14. The elements 18 also exhibit swirl structures 41, which help to impart swirling to the liquefied gas in the pipe 14. The swirling phenomena in the pipe 14 lead to a reduction in the thickness of the vapour layer between the liquefied gas and the pipe wall 23, as a result of which the efficiency of the transfer of cold from the liquefied and warming gas to the air for cooling 39 is increased. The baffles can be made of a material other than the pipe wall 23, for example the baffles can be made of plastic. It is advantageous if the baffles 21 are produced from a material with high thermal conductivity and are connected to the pipe wall 23 in such a way as to ensure high thermal conductivity. Heat transfer resistance between the baffles 21 and the pipe wall 23 can be reduced, for example by soldering or welding. The lowest possible resistance to thermal transfer is advantageous with a view to ensuring the most efficient possible transfer of the cold contained in the liquefied gas to the fins 17.

FIG. 8 depicts a cross section through the pipe 14 according to FIGS. 6 and 7 as a sectioned view perpendicular to the longitudinal axis 19. The elements are present as transposed, star-shaped baffles 21, which are inserted in the form of profile rods 22 into the interior of the pipe 14. The cross sections of the profile rods 22 are executed as a star with 5 radial arms, which are soldered to the pipe wall 23. The individual radial arms exhibit swirl structures 41, which are formed by undulations or surface roughness on the profile rods. The turbulence inside the pipe 14 is increased both by the baffles as such, and by the swirl structures 41 on the baffles 21, as a result of which an improved transfer of cold from the liquefied gas to the fins 17, and thus to the cooling air for cooling 39, is achieved.

FIG. 9 depicts a further embodiment of a pipe 14, in which no fins 17 are shown in the interest of greater clarity. This embodiment is concerned with a transposed flat pipe, where the pipe 14 exhibits an internal pipe cross section which varies along the length of the pipe 14. The internal cross-sectional surface of the pipe 14 is preferably round, elliptical or strongly elliptical and is twisted along the length of the pipe 14. In particular, the surface of the projection of a first internal pipe cross section at a first pipe location 15 onto a second internal pipe cross section at a second pipe location 16 is less than 30% of the surface of the internal pipe cross section. The two pipe locations 15, 16 are displaced by 100 mm along the longitudinal axis 19 in this case. A centrifugal separation of the liquid (external) and the gas (internal) is produced by the twisting of the flat pipe in conjunction with the flow through the pipe 14, which intensifies the thermal contact between the liquefied gas and the pipe wall 23.

Whereas baffles 21 are provided in the interior of pipes 14 in order to generate turbulences in the pipe 14 in the embodiment according to FIG. 7, the pipe as such is profiled in the embodiment according to FIG. 9, in particular being transposed or undulating, in order to generate a turbulence in conjunction with the flow.

FIG. 10 depicts a heat exchanger housing 29 for the heat exchanger 30, which is conceived as a catch tank for installation internally in the heat exchanger 30, in order to catch the dripping meltwater in conjunction with defrosting and to lead it away via a drain channel (not shown). The catch tank 31 can exhibit additional heating elements 32, with which ice can be defrosted. The heat exchanger housing 29 exhibits flow channels 7 for the cooling air for cooling 39 or the refrigerated cooling air 27. The heat exchanger housing 29 in this case exhibits discharge openings 33, which include edges 34, by means of which the liquid water produced during defrosting can be arrested, so that it is not blown into the refrigerated chamber 4, 9 by the fan. Icing-up of the flow channels 7 by meltwater is prevented particularly effectively by this means. The arresting edges can be in the form of skirts, labyrinth structures or deflector plates, for example.

FIG. 11 depicts the refrigeration module 10 of the kind that can be used, for example, in a refrigerated vehicle according to FIG. 1 as a perspective three-dimensional oblique view in the opened form. A particularly compact design is achieved through the modular arrangement of the ventilators 8, the phase separators 24 and the pipes 14.

FIG. 12 depicts schematically a cooling system according to the invention with a pressure controller 38 for the purpose of conveying liquefied gas from the tank 5 into the evaporator 1 without resorting to the use of a motorized pump. The cooling system exhibits a means 20 for testing the gas tightness of the cooling system 45, the heat exchanger 30 or the evaporator 1. The evaporator 1 is connected to the tank 5 in such a way as to permit a flow via the line 42 for liquefied gas. Liquefied gas is forced into the line 42 in a direction of flow 54 of the liquefied gas by a pressure arising in the tank 5. In order to increase the pressure in the tank 5, the line 42 is closed by means of a valve 49, in conjunction with which a component of liquefied gas in the line 42 is caused to vaporize upstream of the valve 49, that is to say between the valve 49 and the tank 5, by warming of the line 42. The valve 49 is also designated as an inlet valve. The line can exhibit thermal insulation, such as dual-wall vacuum insulation (super-insulation) or a foam jacket. As a general rule, the thermal input is great enough, in spite of this thermal insulation, to vaporize a sufficiently large component of liquefied gas in the line 42 upstream of the valve 49, and to increase the pressure in the tank 5. In specific cases, it may be appropriate to provide a thermal bridge 51 in the line 42 upstream of the valve 49, which bridge takes care of the necessary thermal input. The thermal bridge 51 can be formed by a reduction in the insulation on the line 42, in conjunction with which the thermal bridge is provided in particular on a section of the line 42 and is advantageously arranged in a variable manner in respect of a heat transfer coefficient. The valve 49 is opened in pulses, causing liquefied gas to be forced in the direction of flow 44 into the line 42 and conveyed into the heat exchanger 30. No stationary condition occurs due to the pulsed operation of the valve 49 in the line 42, so that the temperature in the line 42 upstream of the valve 49 fluctuates laterally according to the closed condition of the valve 49 and the removal of gas from the tank 5.

In order to ensure an adequate build-up of pressure in the tank 5, the internal volume of the line 42 upstream of the valve 49 as far as the opening on the tank 5 is at least approximately 1/1000 of the internal volume of the tank 5. The heat exchanger is arranged inside a refrigerated chamber housing 3 and liberates refrigerated cooling air 27 to the refrigerated chamber 4. For this purpose, the air inside the refrigerated chamber 4 is recirculated with the help of a ventilator 8, which is driven by a motor 52. Inside the refrigerated chamber 4, an initial temperature sensor is provided at a first point 46, in order to determine temperature fluctuations. If the temperature inside the refrigerated chamber 4 falls abruptly at a rate of more than 5° C. per minute, an initial warning signal is given, which draws the attention of the operator of the refrigerated vehicle 2 to the possible presence of a leak in the cooling system 45. An additional temperature sensor 53, which serves the same purpose, can be provided inside the refrigerated chamber 4 at an additional first point 46.

The motor 52 can be operated as an electric motor or pneumatically utilizing the vaporized gas. The liquefied gas is conveyed downstream of the valve 49 through the evaporator 1 and the heat exchanger 30 as far as an additional valve 55. The vaporized gas is then released into the environment as exhaust gas 56 via the exhaust pipe 6. The line section 57 of the line 42 between the valve 49 and the additional valve 55 can be closed off with the help of the two valves 55, 49. It is possible in this case in particular to enclose a positive pressure if the line section 57 is gas tight. Provided on the line section 57 at a second point 47 is a pressure sensor 35, which registers the chronological pressure sequence in the line section 57. If a positive pressure enclosed between the valves 55, 49 falls below a set value, or if the positive pressure varies more rapidly than a set reference value, for example more rapidly than 0.2 bar per minute, a second warning signal will be given. The first warning signal and the second warning signal are indicated to the driver of the refrigerated vehicle 2 on an indicator instrument (see FIG. 2). The valve 49, the additional valve 55, the pressure sensor 35 and the temperature sensors 37 and 53 constitute the means 20 for testing the gas tightness of the heat exchanger 30, the evaporator 1 and the cooling system 45. The additional valve 55 is also designated as an exhaust valve.

Use is made advantageously of at least two heat exchangers 30 and at least two evaporators 1, which defrost and cool alternately. Greater operating reliability is achieved in this way. Energy costs, which arise as a result of an active defrosting process in the event of ice formation on the heat exchanger 30 and on the evaporator 1, can also be reduced significantly by this means.

A homogeneous material pairing should be used for the choice of material of the heat exchanger. Heat exchangers made of aluminium or copper have proven themselves in service in low-temperature engineering. For production engineering reasons, a homogeneous choice of materials consisting of copper pipes and copper fins is preferably selected, although other suitable materials can also find an application. Heat exchanger pipes are used in this application preferably as ribbed pipes, which consist homogeneously of copper and possess copper fins on the outer envelope surface. These can be soldered, welded, clamped or attached to or installed on or in the outer envelope surface by other methods. The fins 17 are preferably pressed from the pipe material by rolling processes and are then provided with an undulation on the lateral surface. This fin undulation is produced in the final rolling operation. In the event of a transverse laminar flow through the pipe, the undulating form produces a turbulent airflow between the fins 17, which manifests itself positively on the air side as higher heat transfer coefficients. The rolled fins 17 preferably run along the periphery in the form of a screw with a distance between the fins of between 2 and 10 mm, and preferably 3 mm. Other distances between the fins can be used, however. The pipes 14 provided with fins 17 are preferably held in end fins. The expression end fin is understood to denote a plate provided with holes, through which the pipe connections of the pipe lines are passed. Around the holes, slots are drawn through the end fins in such a way that the pipes are able to move individually in each case in relation to the attachment points of the end fin. The pipe ends preferably project beyond the end fins. The end fins, which preferably consist of copper, and the pipe connections of the ribbed pipes are securely attached to the end fins, preferably by soldering. The pipe ends of the pipes 14 provided with fins projecting from the end fins are connected to one another with copper pipes or bridges.

In the initial phase of the transmission of heat from the liquid nitrogen to the pipes, a phase transition from the liquid to the gaseous physical condition takes place in the heat exchanger pipes. During this change in physical condition, a liquid-vapour mixture reaction takes place through film and nucleate boiling. Experience shows that high accelerations of the liquid due to vapour bubbles formed in the direction of flow ahead of the liquid occur as the result of nucleate boiling inside pipes.

In previously disclosed evaporators 1, the resulting small vapour bubbles are combined into large vapour bubbles in fractions of a second and propel the column of liquid in front of them through the heat exchanger pipe at an explosive rate as a result of the change in volume. In previously disclosed heat exchangers, only an inadequate transmission of heat from the liquefied gas to the pipe wall 23 takes place through this process.

In the heat exchanger 30, elements are installed inside the pipe 14 which permit the most uniform vaporization possible inside the heat exchanger pipes and increase the heat transfer coefficients in this way. In order to achieve this optimization, flow profiles or baffles 21 are inserted inside the pipes 14, which ensure that the liquid always flows on the internal surface of the pipe wall 23. Profile rods 22 are used, for example, which divide the pipe cross section longitudinally into n sections. These sections are executed as circle segment profiles, in which the angle of the circle segment begins at the centre of the pipe and extends to the envelope surface. It is also possible to use other geometries, although these should only form the largest possible spatial volume on the inside of the pipe envelope. Preferably five radial internal profiles in the form of an internally located star are used. This star is twisted about the longitudinal axis. As already mentioned, at the time of entering the heat exchanger pipe, the liquefied nitrogen experiences acceleration due to the vapour bubbles that are formed and the change in volume resulting therefrom. The twisting or transposition of the profile rod 22 with n radial arms about the longitudinal axis 19 causes flow channels to be produced in the pipe 14, which channels exhibit the form of a coil internally along the envelope surfaces of the pipe wall 23. A transposition of the internal profile with n radial arms can be undertaken as required about the longitudinal axis 19 in relation to a length of the pipe 14. However, channels must still be present in the pipe after the twisting. The internal part is twisted between two times and ten times, and preferably three times per metre about the longitudinal axis 19. Twisting of the profile rod 22 with n radial arms presses the fluid that is caused to accelerate by centrifugal forces against the internal envelope surface and conveys it along the pipe. As a result of the difference in temperature between the liquid and the internal envelope surface, the physical condition of the liquefied nitrogen is changed by nucleate boiling. The heat transfer coefficients are increased significantly in this way. The liquefied gas can be almost entirely vaporized after a comparatively short distance.

All the pipes 14 present in the heat exchanger can be charged with liquid nitrogen. Preferably two pipes 14 are charged with liquid nitrogen. The ribbed pipes of the heat exchanger that are charged with liquid nitrogen are preferably the uppermost pipes in the geodetic sense. The two highest pipes in the geodetic sense on the air outlet side are preferably used for the purpose of charging with fluid. In this way, a counterflow between the air flow for cooling and the flow of nitrogen is superimposed on the transverse flow.

A phase separator 24 is advantageously connected downstream of the ribbed pipes 14 charged with fluid with a twisted star situated internally. The phase separator 24 collects any drops of liquid that have not been vaporized, which have not come into contact or have made only inadequate contact with the internal envelope surface. The phase separators are preferably configured as a horizontal pressure vessel. An inlet pipe is preferably routed for a short distance beneath the geodetically upward-facing envelope surface through the end face. The outlet pipes are present on the opposite side of the inlet pipe, and an outlet pipe is preferably routed geodetically for a short distance above the otherwise subjacent envelope surface through the end face.

The task of the phase separator 24 is to collect the entrained liquid components and to convey them back to the heat exchanger through the subjacent outlet pipe of the following pipe (ribbed pipe) exhibiting fins. Any collected nitrogen that remains unvaporized is preferably conveyed back to the two ribbed pipes, which are present at the lowest point in the geodetic sense on the air outlet side.

The downstream ribbed pipes 14 with a twisted internally situated profile rod 22 serve as pre-heaters for the gaseous nitrogen. N pipes can be connected downstream, in order to heat the gaseous nitrogen up to the stipulated exhaust gas temperature. Preferably six pipes are used as pre-heaters, in which case the two return pipes from the phase separator are also counted as pre-heaters.

The heat exchanger can preferably also be operated only as a pre-heater. For this purpose, the gas temperature at the inlet should lie significantly below the air inside the chamber to be refrigerated.

A means of resistance heating is provided, since it is not possible, for process engineering reasons, for a heat input for defrosting to be taken from the interior of the pipe 14. This defrosting heating can disperse any icing-up. In particular the fluctuations in temperature from −196° C. to +100° C. arising in this case require the heating and the pipes to possess special characteristics. An electrical heating means is used for defrosting, preferably with at least 2 to 40, and for example 9, silvered copper strands, which in each case can exhibit a diameter of 0.1 mm to 0.5 mm, for example 0.25 mm. The copper strands are contained in a sheath made of polymer, such as polytetrafluoroethylene (PTFE), to provide electrical insulation. The silvered copper strands with a PTFE sheath are wound helically between the fins 17 as far as the base of the ribbed pipe, so that contact is established between the heating cable and the copper of the ribbed pipe between each fin 17 and the base of the fin. Uniform heat distribution for defrosting is possible in this way on the entire heat exchanger.

In order to achieve targeted routing of the airflow over the entire heat exchanger, a heat exchanger housing 29 is designed as a covering hood, which on the one hand functions as a catch tank 31 for condensate water, and on the other hand assures the routing of the airflow inside the heat exchanger 30. In addition, the heat exchanger housing 29 also determines the air extraction direction in a targeted manner. The air extraction direction is set, as necessary, on the front or optionally to the left, to the right or simultaneously to the left and to the right, by the expedient of providing reference breaking points in the housing of the heat exchanger such that parts of the housing which point in the desired air extraction direction can be readily broken open. A heat exchanger housing made of plastic, for example a plastic of the polystyrene/polyethylene material pairing, is preferably selected because of the large differences in temperature. This material pairing is characterized by its small thermal deformation. Moreover, the material can be readily formed and offers the possibility of internal insulation in order to avoid condensate on the outside.

The heat exchanger and the evaporator is advantageously equipped with a device for optimizing the transmission of heat for the vaporization of liquefied gases, and in particular for low-temperature liquefied nitrogen, which serves as an air cooler, in conjunction with which the heat exchanger and the evaporator consists of ribbed pipes with rolled, undulating fins running round in the form of a screw. In this case, the material pairing of the heat exchanger pipe and the fins in particular consists of a homogeneous metal. The homogeneous metal can be copper. Inside the ribbed pipes in particular, a flow profile is used which divides the cross section of the pipe longitudinally into n sections, in conjunction with which these sections can be executed as circle segment profiles, and/or the angle of the circle segment begins at the centre of the pipe and can extend as far as the envelope surface. Other geometries can also find an application here, which advantageously constitute the largest spatial volume on the inside of the pipe envelope. It is advantageous to use internal profiles with multiple radial profiles, and in particular five radial profiles, in the form of an internally located star profile. There is a particular preference to transpose the profile situated inside the ribbed pipe about the longitudinal axis, as a result of which helical channels, which taper towards the centre of the pipe, are formed inside the pipe. The flow profile present inside the ribbed pipe can divide the cross section of the pipe at least once. Advantageously, the flow profile present inside the ribbed pipe, which divides the pipe cross section at least once, is twisted helically in such a way that at least two helical fluid channels are formed inside the pipe. The pipes that are charged with liquid nitrogen are advantageously the geodetically uppermost pipes on the air outlet side. The ribbed pipes are advantageously soldered in each case on a copper end fin on either side. A horizontal phase separator 24 can be formed and/or welded on the end fin in each case as a pressure container. The inlet pipe into the phase separator 24 can be introduced into the phase separator in the upper area of the end surface, at a short distance below the envelope surface of the pressure container. The outlet pipe can be routed from the phase separator in the lower area of the end surface, at a short distance above the envelope surface of the pressure container. The plastic part of the heat exchanger can be made from a thermoplastic plastic (preferably polyethylene, PE) in a compression mould or a drawing mould. A material pairing of polystyrene/polyethylene is advantageous in view of the high temperature differences and the need for insulation.

Various additional aspects that are closely associated with the invention are described below. The individual aspects can be applied individually in each case, that is to say independently of one another, or can be combined with one another as required. These aspects can also be combined with the previously described aspects.

A particularly advantageous mobile refrigerated vehicle 2 in terms of its operating reliability, dependability and energy-efficiency comprises a refrigerated chamber housing 3 for at least one refrigerated chamber 4 contained therein, a tank 5 for liquefied gas, an evaporator 1 for vaporizing the liquefied gas while liberating cold to the refrigerated chamber 4, and an exhaust pipe 6 for the vaporized gas, the evaporator 1 being arranged outside the refrigerated chamber 4. The liberation of the cold from the evaporator 1 takes place advantageously to refrigerated air, which is conveyed via flow channels 7 from the refrigerated chamber 4 to the evaporator 1, and from the evaporator 1 to the refrigerated chamber 4. Provided in particular for this purpose is a ventilator 8, which is arranged outside the refrigerated chamber 4, in conjunction with which the ventilator 8 and the evaporator 1 can be attached as a refrigeration module 10 on the refrigerated vehicle 2. The refrigerated vehicle 2 exhibits in particular at least one first refrigerated chamber 4 for temperatures below 0° C., and in particular below −10° C., and at least one second refrigerated chamber 9 for temperatures above 0° C., and in particular between +4 and +10° C. The evaporator 1 can be arranged in an upper area 11, in particular on the roof or on the face, of the refrigerated vehicle 2. The tank 5 can be arranged in a lower area 12 of the refrigerated vehicle 2, in particular underneath the refrigerated vehicle 2. Provided on the tank 5 is in particular a pressure controler 38, in particular with a pressure build-up means 13, for example a resistance heating means, through which the liquefied gas is forced into the evaporator 1. A means 20 for testing the gas tightness of the cooling system, and in particular the evaporator 1, is advantageously provided. The necessary heating energy can be taken from the environment.

An advantageous method for refrigerating a refrigerated chamber 4 of a mobile refrigerated vehicle 2 comprises the following process stages: removal of a liquefied gas from a tank 5 and supply of the gas into an evaporator 1 arranged outside the refrigerated chamber 4; removal of a flow of cooling air for cooling from the refrigerated chamber 4; evaporation of the liquefied gas in the evaporator 1 and utilization of at least a part of the cold component for the refrigeration of the flow of cooling air; introduction of the refrigerated flow of cooling air into the refrigerated chamber 4.

With a view in particular to achieving a high degree of cold utilization, a particularly advantageous heat exchanger 30 for a mobile refrigerated vehicle 2 having a tank 5 for liquefied gas comprises at least one pipe 14 for receiving a flow of a liquefied gas and for the vaporization of at least one component of the liquefied gas, in conjunction with which the pipe 14, at least in sections, exhibits a longitudinal axis 19, and the heat exchanger 30 comprises an inlet side 26 for liquefied gas and an outlet side 25 for at least partially vaporized gas, and in conjunction with which the outlet side 25 is connected to an exhaust pipe 6 in such a way as to permit a flow, in conjunction with which the pipe 14 exhibits elements 18 in its interior for the purpose of generating turbulences in the flow or for the purpose of generating a radial separation of the liquid and gaseous phase. A gas interface layer thickness on a pipe wall 23 is reduced by the flow turbulences, as a result of which the thermal contact of the liquefied gas with the pipe wall is improved. In particular the elements 18 in this case are constituted by baffles 21 in the pipe 14, in particular by profile rods 22 or profile strips extending along the longitudinal axis 19, in conjunction with which the profile rods 22 or the profile strips are advantageously star-shaped, and in particular having at least two radial profiles, preferably at least three radial profiles, and for example at least 5 radial profiles. The baffles 21 can extend in a twisted fashion along the longitudinal axis 19. The baffles 21 can extend in an undulating fashion along the longitudinal axis 19. The pipe 14 advantageously exhibits a pipe wall 23, and the pipe wall 23 is profiled, and in particular undulating or transposed, along the longitudinal axis 19. The pipe 14 can exhibit an internal pipe cross section which varies along the pipe 14. In particular, the surface of the projection of a first internal pipe cross section at a first pipe location 15 onto a second internal pipe cross section at a second pipe location 16 is less than 90%, in particular less than 70%, and preferably less than 50%, of the surface of the internal pipe cross section. The first and the second pipe locations are displaced by 100 mm along a longitudinal direction of the pipe in this case.

The pipe 14 can exhibit on its outside in particular rolled fins 17, which fins 17 run round in the form of a screw and/or are undulating. The pipe 14 and the elements 18 are made in particular of a homogeneous material, in particular copper, in particular pressed, welded or soldered from a single piece from the external area of the fluid-conducting pipe. Thermally induced distortions are reduced in this way. The elements 18 can divide an internal pipe cross section of the pipe 14 into at least two, in particular at least 3, and preferably at least 5 cross sections of the internal part of the pipe. The ratio of the total surface of the wall to the volume of the pipe is improved in this way. In particular, the cross sections of the internal part of the pipe extend radially outwards. A phase separator 24 for separating liquefied gas from vaporized gas is provided, which is connected to the outlet side 25 in such a way as to permit a flow. The phase separator 24 can be configured as a pressure vessel. The inlet side 26 for the liquefied gas can be arranged geodetically above the outlet side 25 for the at least partially vaporized gas. The heat exchanger 30 advantageously exhibits a resistance heating means 28 wound helically around the pipe 14. Any ice formed on the heat exchanger can be removed in this way. A catch tank 31 for condensate can be provided underneath the pipe 14, in conjunction with which the catch tank 31 in particular exhibits a heating element 32. The heat exchanger 30 can exhibit a heat exchanger housing 29 in particular made of a thermoplastic plastic, which assures the routing of the airflow inside the heat exchanger 30, in conjunction with which in particular a discharge opening 33 is provided, which exhibits arresting edges 34 for the purpose of arresting drops of water. With the help of the arresting edges 34, it is possible to prevent the meltwater from being blown into the flow channels 7 and from being turned into ice there. Advantageously, at least one pressure sensor 35 is provided on the heat exchanger 30 and a means 20 for testing the gas tightness of the cooling system, in particular of the heat exchanger 30 is provided, in conjunction with which in particular a temperature sensor 37 is provided on the heat exchanger 30 and is connected electrically to the means 36 for testing the gas tightness. A positive pressure is built up for this purpose in the pipework system for the liquefied gas, and observations are made to establish whether this positive pressure remains stable. A drop in the pressure indicates a leak. The temperature sensors are used to establish whether the liquid gas affecting the pressure measurement is present in the pipe. In order to exclude the possibility of a constant pressure being attributable to a defective supply valve, functional testing of the valves is also performed in the context of the gas tightness testing. This initially relieves the pressure from the volume to be tested and blocks the atmospheric pressure that is present in the test volume. This must not increase, as a leak on the supply side must otherwise be assumed.

A particularly advantageous method for generating a positive pressure in a tank 5 for liquefied gas in a refrigerated vehicle 2 with an evaporator 1 for the liquefied gas, where the evaporator 1 is connected to the tank 5 in a fluid-conducting manner via a line 42 for liquefied gas, and where a valve 49 is arranged in the line 42, comprises the following process steps: opening the valve 49 and permitting liquefied gas to pass from the tank 5 into the line 42; closing the valve 49 in such a way that a component of the liquefied gas remains in the line 42 and is able to flow back into the tank 5; heating the component in the line 42. In this way, heat/energy is introduced into the tank, where it leads to an increase in pressure. The line 42 is preferably heated in such a way that the component present therein is vaporized at least partially. Highly efficient operation of the refrigeration process and the refrigerated vehicle without the use of a motorized pump is possible with this procedure. At the time of closing the valve 49 in the line 42 upstream of the valve 49, a volume of liquefied gas of at least 1/1500, in particular at least 1/700 and, for example, at least 1/300 of the volume of the tank 5 is advantageously enclosed. The process of heating causes the vaporization of in particular at least 10%, in particular at least 20% and, for example, at least 50% or at least 80% of the liquefied gas component remaining in the line 5. Heating can be performed on the line 42 by means of environmental heat.

A particularly advantageous method for conveying liquefied gas from a tank 5 into an evaporator 1 of a refrigerated vehicle 2 situated in a geodetically higher point, where the evaporator 1 is connected to the tank 5 via a line 42 for liquefied gas in such a way as to permit a flow, and a valve 49 is arranged in the line 42, comprises the following steps: building up a positive pressure in the tank by the method for building up a pressure according to the invention, and opening the valve 49 and permitting the liquefied gas to be forced into the evaporator 1 by the positive pressure. The valve 49 is opened in particular in pulses for the purpose of building up the pressure.

A particularly advantageous device for building up a positive pressure in a tank 5 for liquefied gas in a refrigerated vehicle 2 with an evaporator 1 for the liquefied gas, where the evaporator 1 is connected to the tank 5 via a line 42 for liquefied gas in such a way as to permit a flow, and where a valve 49 is arranged in the line 42, comprises a control means for implementing the method for building up a pressure according to the invention, where in particular the internal volume in the line 42 upstream of the valve 49 amounts to at least 1/1500, in particular at least 1/700 and, for example, at least 1/300 of the internal volume of the tank 5. The line 42 advantageously exhibits thermal insulation, in conjunction with which in particular the line or its insulation upstream of the valve 49 exhibits a thermal bridge 51 such that or a thermal capacity such that adequate heating of the liquid nitrogen present in the tank 5 can be achieved.

The device for building up a pressure according to the invention provides an advantageous cooling system 45 for a refrigerated vehicle 2 with at least one refrigerated chamber 4, 9, a tank 5 for liquefied gas and an evaporator 1 for the evaporation of the liquefied gas and the liberation of cold to the refrigerated chamber 4, 9, where the evaporator 1 is connected to the tank 5 via a line 42 for liquefied gas in such a way as to permit a flow, and where a valve 49 is arranged in the line 42.

The invention relates to a method for monitoring the gas tightness of a cooling system 45 for a refrigerated vehicle 2 comprising the following steps: recording of a chronological temperature sequence at least at a first point 46 in the cooling system 45 and the determination of any change in the temperature at the first point 46 within a first time interval, and comparison of the change with a first reference value and triggering of a first warning signal in the event that the change exceeds the first reference value; and/or subjecting a line section 57 of the cooling system 45 to a positive pressure and blocking this line section 57 recording a chronological pressure sequence at least at a second point 47 in the line section 57 and the determination of any change in the pressure at the second point 47 within a second time interval and comparison of the change with a second reference value and triggering of a second warning signal in the event that the change exceeds the second reference value. The invention also relates to a method for operating a cooling system, a cooling system and a refrigerated vehicle, in conjunction with which use is made of the method according to the invention. The invention is characterized by high operating safety, operating reliability and economic viability.

### LIST OF REFERENCE DESIGNATIONS

1 Evaporator
2 Refrigerated vehicle
3 Refrigerated chamber housing
4 Refrigerated chamber
5 Tank
6 Exhaust pipe
7 Flow channels
8 Ventilator
9 Refrigerated chamber
10 Refrigeration module
11 Upper area
12 Lower area
13 Pressure build-up means
14 Pipe
15 First pipe location
16 Second pipe location
17 Fins
18 Elements
19 Longitudinal axis
20 Means for testing the gas tightness of the heat exchanger 30 and the evaporator 1
21 Baffles
22 Profile rods
23 Pipe wall
24 Phase separator
25 Outlet side
26 Inlet side
27 Refrigerated cooling air
28 Resistance heating means
29 Heat exchanger housing
30 Heat exchanger
31 Catch tank
32 Heating element
33 Discharge opening
34 Arresting edges
35 Pressure sensor
36 Supply line for phase separator 24
37 Temperature sensor
38 Pressure controller
39 Cooling air for cooling
40 Return line for the phase separator 24
41 Swirl structure
42 Line for liquefied gas
43 Electrical line
44 Indicator instrument
45 Cooling system
46 First position
47 Second position
48 Door
49 Valve
50 Face
51 Thermal bridge
52 Motor for ventilator
53 Temperature sensor
54 Direction of flow of liquefied gas
55 Additional valve
56 Exhaust gas
57 Line section

1.-18. (canceled)

19. A method for monitoring the gas tightness of a cooling system for a refrigerated vehicle comprising the following steps:
recording of a chronological temperature sequence at least at a first point (46) in the cooling system and the determination of any change in the temperature at the first point within a first time interval;
comparison of the change with a first reference value and the triggering of a first warning signal in the event that the change exceeds the first reference value.

20. A method for monitoring the gas tightness of a cooling system for a refrigerated vehicle comprising the following steps:
subjecting a line section of the cooling system to a positive pressure;
blocking this line section;
recording a chronological pressure sequence at least at a second point in the line section and the determination of any change in the pressure at the second point within a second time interval;
comparison of the change with a second reference value and the triggering of a second warning signal in the event that the change exceeds the second reference value.

21. The method of claim 20, wherein the method is repeated after a time delay, if the pressure increases.

22. The method of claim 20, wherein a further warning signal is generated if the pressure lies below a set minimum pressure.

23. The method according to claim 19, wherein in the event that the first warning signal is triggered, the following further steps are performed:
subjecting a line section of the cooling system to a positive pressure;
blocking the line section;
recording a chronological pressure sequence at least a second point in the line section;
determining any change in the pressure at the second point within a second time interval;
comparing the change with a second reference value, wherein a second warning signal is triggered in the event that the change exceeds the second reference value.

24. The method of claim 19, comprising the following consecutive steps:
a) Closing of a valve between a tank and at least one of the following elements: a heat exchanger and an evaporator in conjunction with the at least occasionally simultaneous opening of an additional valve, via which a flow connection to an exhaust pipe can be produced, and the measurement of the pressure between the valve and the additional valve;
b) Closing of the additional valve and measurement of the pressure between the valve and the additional valve; and
c) Opening of the valve and measurement of the pressure between the valve and the additional valve.

25. The method of claim 19, wherein the first reference value corresponds to a temperature drop not exceeding 20° C. per minute, and in particular not exceeding 10° C. per minute, for example not exceeding 5° C. per minute.

26. The method of claim 19, wherein the second reference value corresponds to a pressure drop not exceeding 1 bar per minute, and in particular not exceeding 0.5 bar per minute, for example not exceeding 0.2 bar per minute.

27. The method of claim 19, wherein, for the purposes of a rough test, the first and/or the second time interval exhibits a chronological duration of between 1 second and 300 seconds, and in particular between 5 and 100 seconds, for example between 10 and 60 seconds.

28. The method of claim 19, wherein, for the purposes of a fine test, the second time interval exhibits a chronological duration of between 10 minutes and 24 hours, and in particular between 30 minutes and 12 hours, for example between 1 hour and 4 hours.

29. The method of claim 19, wherein the monitoring of the gas tightness is initiated by the switching off of the refrigerated vehicle.

30. The method of claim 19, wherein the first and/or the second warning signal is indicated optically and/or acoustically with an indicator instrument.

31. The method of claim 19, wherein the monitoring is initiated and/or performed during a defrosting phase of the cooling system.

32. The method for operating a cooling system of a refrigerated vehicle having at least one refrigerated chamber comprising one of the methods for testing the gas tightness of the cooling system according to claim 19.

33. The method of claim 31, wherein the cooling system exhibits a ventilator, and the ventilator is switched on in the event of a gas leakage being detected if a door of the refrigerated chamber is opened.

34. The cooling system for a refrigerated vehicle comprising at least one tank for liquefied gas, at least one evaporator and a means for testing the gas tightness of the cooling system with at least one temperature sensor and/or at least one pressure sensor for the implementation of the method according to claim 19.

35. The cooling system of claim 34, wherein a refrigeration chamber is provided with a door and a ventilator, and the ventilator is taken into operation as soon as the door is opened.

36. The refrigerated vehicle comprising a cooling system according to claim 34.
